(19) United States
(12) Patent Application Publication
(10) Pub. No.: US 2005/0087908 A1
(43) Pub. Date: Apr. 28, 2005

(54) Simulated stone and masonry and brick textured siding panels

(76) Inventors: Moe Nasr, Houston, TX (US); Kurt Kuriger, Willis, TX (US)

Correspondence Address: Al Harrison;Harrison Law Office, P.C., 1018 Preston #100, Houston, TX, 77002, US

(21) Appl. No.: 10/971,861

(22) Filed: Oct. 22, 2004

Related U.S. Application Data
(60) Provisional application No. 60/514,414, filed on Oct. 24, 2003.

(51) Int. Cl. B29C 41/22

(52) U.S. Cl. 264/255; 264/256

(57) ABSTRACT

Simulated stone, masonry and brick textured siding panels are obtained when specially selected materials are properly admixed and formed via molding techniques. These siding panels are manufactured from suitable molds according to a prescribed process methodology using synthetic polymeric materials in addition to stone and masonry and brick materials. Prerequisite surface textures are produced that effectively simulate the corresponding actual stone, masonry and brick panels.

### RELATED APPLICATIONS

This application claims priority based upon Provisional U.S. Application Ser. No. 60/514,414 filed Nov. 24, 2003.

### BACKGROUND OF THE INVENTION

The present invention relates to stone, masonry and brick structures and siding panels, and, more particularly, relates to compositions and processes for manufacturing simulated stone, masonry and brick siding panels from polymer-based composite materials and stone and masonry and brick materials.

It is well known that conventional stone, masonry and brick products such as wall panels, columns, siding panels, light standards, mailbox enclosures, planters, and the like are inherently heavy and cumbersome because of the nature of the underlying stone and masonry and brick materials. In addition, manufacturing of stone and masonry and brick products is likewise difficult and cumbersome because of the well known limitations of working with stone and masonry and brick materials and related binders, glues, etc., especially in a mass-production environment.

Of course, once stone, masonry and brick products are manufactured, there is still the problem of distributing and shipping the heavy structures. Breakage and accidents are, unfortunately, not infrequent. There is presently no reproducible methodology known in the art that enables stone and masonry and brick products to be manufactured from a combination of materials including stone, masonry, and brick. What is needed is a formulation of materials and a methodology for manufacturing simulated stone, masonry and brick products from these materials that afford the textural and functionality associated with stone, masonry and brick structures and products, but none of the infirmities associated with manufacturing, distributing, and installing stone, masonry and brick structures and products, respectively.

### SUMMARY OF THE INVENTION

The present invention teaches simulated stone, masonry and brick textured siding panels that are manufactured from a specially formulated combination of stone and masonry and brick materials and non-stone and non-masonry and non-brick materials that, when properly admixed, are formed via molding techniques. Since these products are manufactured from formulations of materials based upon synthetic polymeric materials and natural mineral materials, the simulated stone, masonry and brick panels are lightweight, safer to assemble into structures and products than conventional stone, masonry and brick structures and panels, and are easier to distribute and transport.

In another aspect of the present invention, special molding techniques have been discovered that engender the prerequisite textural surface attributes contemplated by the present invention—that effectively simulate actual stone, masonry and brick panels and structures.

These and other objects and features of the present invention will become apparent from the following detailed description, wherein reference is made to the figures in the accompanying drawings.

### IN THE DRAWINGS

FIG. 1 is a block diagram of the step-wise molding process used for manufacturing the preferred embodiment of the present invention

FIG. 2 is simplified frontal view of a prior art simulated stone and/or masonry and/or brick textured panel.

FIG. 3 is simplified frontal perspective view of the preferred embodiment of the present invention, corresponding to a simulated stone and/or masonry and/or brick textured panel.

FIG. 4 is a rear view of the preferred embodiment depicted in FIG. 3.

FIG. 5 is a side view of the preferred embodiment depicted in FIG. 4.

### DETAILED DESCRIPTION

The present invention teaches a combination of materials and molding manufacturing method for producing simulated stone, masonry and brick textured structures and panels hereinbefore unknown in the art. The preferred embodiment of the present invention constitutes a “Tuftek” wall panel that resembles each of a conventional stone, brick, and/or masonry wall. As will be readily understood by those skilled in the art, such conventional stone, brick, and/or masonry walls may be constructed from a diversity of component stones. It has been discovered that the simulated stone, masonry and brick texture structures of the present invention may be manufactured with suitable colors that emulate the corresponding colors of the natural stones that are being simulated in the underlying formulation.

The combinations of the present invention comprise an admixture of component materials that, when processed using molding techniques—in a mold suitably configured to engender the intended form—produce simulated stone, masonry and brick structures and panels that afford a panoply of textural and structural properties that have heretofore been unknown in the art. It is, of course, well known in the art that commonly used molding techniques include blow molding, vacuum molding, rotational molding, compression casting, etc. As will be hereinafter described, formulations of the present invention include polymeric materials, colorants or coloring materials applicable to concrete, stone, brick. and sand; binder or glue compounds; and tires for imparting bulk and the like to the admixture.

As is well known in the art, various molding procedures have afforded means for exploiting an unique ensemble of capabilities and properties of polymeric materials. Of particular applicability to the present invention is the combination of colors, surface textures and finishes that materials acquire when manufactured by molding techniques contemplated hereunder. As will be readily understood by those conversant in the art, panels taught by the present invention may be more economically manufactured than similar panels manufactured via conventional molding, or via carving stone and masonry materials. Nevertheless, while preferred embodiments of the present invention are produced by application of molding processes, other embodiments of the present invention can be produced by adapting a diversity of molding techniques known in the art.

Composite mixtures suitable for manufacturing simulated stone, masonry and brick textured panels preferably via molding processes contemplated hereunder preferably comprise the following components:

| No. | Component | % by Volume |
|---|---|---|
| 1 | Tires | 5-40 |
| 2 | Dried Solids | 3-3.5 |
| 3 | Polymer | 60-80 |
| 4 | Glue | 3-10 |
| 5 | Sand | 10-22 |
| 6 | Cement | 5-11 |
| 7 | Coloring | 5-12 |
| 8 | Color Hardener | 4-14 |

As will be appreciated by those skilled in the art, selection of a suitable molding powder or resin is an important factor prerequisite for a successful molding operation. It has been found that suitable UV-stabilized polyethylene raw material resins that are commercially available from several manufacturers, with a melt index in the range 2.0-6.5, are particularly applicable to embodiments of the present inventions. Resins having acceptable combination of density per ASTM D-1505 and melt index per ASTM D-1238 (condition 2.16, 190) are illustrated in Table 1. It will be appreciated that these formulations—in conjunction with the manufacturing techniques taught hereunder—produce panels having superior mechanical properties, e.g., higher stiffness, excellent low temperature impact strength and environmental stress crack resistance.

TABLE 1
Polyethylene By Ascending Melt Index

| | 1 | 2 | 3 | 4 | 5 | 6 |
|---|---|---|---|---|---|---|
| Density | .941 | .938 | .938 | .941 | .935 | .936 |
| Melt Index | 2.0 | 2.6 | 3.5 | 4.0 | 5.9 | 6.5 |
| Flexural | 130,000 | 95,000 | 102,000 | 120,000 | 87,000 | 80,700 |
| Modulus | | | | | | |

Polyethylene raw materials contemplated by the present invention may be readily obtained from suppliers worldwide. Suppliers in the United States include Southern Polymer, Inc. of Atlanta, Ga.; Mobil Chemical of Edison, N.J.; Millennium Petrochemicals Inc. of Cincinnati, Ohio; H. Muehlstein & Company, Inc. of Houston, Tex.; Chroma Corporation of McHenry, Ill.; A.Schulman, Inc. of Akron, Ohio; and Formosa Plastics. For instance, a Southern Polymer LLDPE resin corresponding to properties shown in column 4 of Table 1, includes a tensile strength of 2,700 psi per ASTM D-638 (2″ per minute, Type IV specimen, @ 0.125″ thickness), heat distortion temperature of 53° C. @ 66 psi and 40° C. @ 264 psi per ASTM D-648, low temperature impact of 50 ft. lbs. for a ⅛″ specimen and 190 ft. lbs. for a ¼″ specimen per ARM Low Impact Resistance.

As another example, Millennium Petrochemicals sells LLDPE resin GA-635-661 corresponding to properties shown in column 6 of Table 1, which includes a tensile strength of 2,500 psi per ASTM D-638, heat distortion temperature of 50° C. @ 66 psi and 35° C. @ 264 psi per ASTM D-648, low temperature impact of 45 ft. lbs. for a ⅛″ specimen and 200 ft. lbs. for a ¼″ specimen per ARM Low Impact Resistance, and ESCR Condition A, F50 of greater than 1,000 hrs. per ASTM D-1693 @ 100% Igepal and 92 hrs. @ 10% Igepal. Similarly, Mobil Chemical sells MRA-015 corresponding to properties shown in column 5 of Table 1, which includes a tensile strength of 2,650 psi, heat distortion temperature of 56° C. @ 66 psi and 39° C. @ 264 psi, low temperature impact of 58 ft. lbs. for a ⅛″ specimen and 180 ft. lbs. for a ¼″ specimen, and ESCR Condition A, F50 of more than 1,000 hrs. @ 100% lgepal. Similarly, Nova Chemicals sells TR-0338-U/UG corresponding to properties shown in column 3 of Table 1, which includes a tensile strength of 3,000 psi, heat distortion temperature of 50° C. @ 66 psi, low temperature impact of 60 ft. lbs. for a ⅛″ specimen, and ESCR Condition A, F50 of more than 1,000 hrs. @ 100% lgepal.

As yet another example is Formosa Plastics' Formolene L63935U having Melt Index of 3.5 and density of 0.939, along with flexural modulus of 110,000 psi, a tensile strength of 3,300 psi at yield, heat defection temperature of 54° C. @ 66 psi, low temperature impact of 60 ft. lbs. for a ⅛″ specimen, and ESCR Condition A, F50 of greater than 1,000 hrs. @ 100% lgepal and 60 hrs. @ 10% lgepal.

Another component of the combinations of materials taught by the present invention is a latex adhesive adapted to accomplish the purposes herein described in detail. For instance, XP-10-79 C pressure sensitive adhesive of Chemical Technology Inc. (Detroit, Mich.) is a water base adhesive with a styrene butadiene adhesive base designed to bond various foam substrates, polyethylene and polystyrene. Representative properties include a viscosity of 5000-7000 cps Brookfield RVT Spindle #3 @ 77° F.; pH 7.5-9.5; weight per gallon of 8.3 lb; no flash point; color blue; 50-54% solids; 20 minutes dry time; no freeze/thaw cycle (should get or be frozen). Another suitable adhesive is Henkel Adhesives (Lewisville, Tex.) polyvinyl resin emulsion 52-3069 having a viscosity of 3750 cps Brookfield RVT @ 76° F.; pH 4.5; weight per gallon of 9.0 lb; 55% solids; 212 boiling point ° F.; specific gravity of 1.1; vapor pressure the same as water @ 20° C.; solubility in water is dispersible when wet; white fluid appearance; polyvinyl odor; no flash point.

It will be appreciated that another component-material of the present invention is pigment colors selected from a broad group of organic, inorganic, mineral oxide, cement, graded silica aggregates, special conditioning admixtures. For example, a suitable pigment color component is Bomanite Color Hardener, among others, which is a dry shake material designed for coloring and hardening concrete flatwork. It is comprised of a blend of mineral oxide pigments, cement, and graded silica aggregates. It has also been found that special conditioning admixtures may be included in preferred formulations to improve workability.

Bomanite Color Hardener has been found to be useful either in its regular grade or in its heavy duty grade. As will be appreciated by those skilled in the art, the regular grade is intended for applications such as residential driveways, patios, pool decks, entryways, walkways, showroom floors, lobbies, and medians. On the other hand, the heavy duty grade, formulated with specially graded Emery, i.e., aluminum oxide for increasing wear resistance, is intended for heavy-traffic applications such as vehicular entrances, theme parks, plazas, crosswalks, street sections, and highly-trafficked sidewalks. As will be understood by those conversant in the art, color hardeners such as Bomanite Color Hardener affords a variety and intensity of colors such that many hues—ranging from soft pastels to vivid blues and purples—may be obtained with improved imprinting, increased durability, and increased resistance to wearing and fading.

As will be readily appreciated by those skilled in the art, another component material taught by the present invention is foam, preferably conventional ½ pound density packing urethane foam. For such structures and panels as simulated stone and masonry and brick wall panels, this urethane foam has been found to impart not only excellent sound absorption qualities, but also structural stability. It should be evident to those skilled in the art that simulated stone, masonry and brick texture wall panels contemplated by the present invention accurately replicate the look-and-feel of stone, masonry, and brick, respectively, and simultaneously replicate some of the physical properties of stone, masonry, and brick.

Molding processes including compression casting have been found to be an advantageous process for manufacturing the simulated stone, masonry and brick structures and panels taught by the present invention.

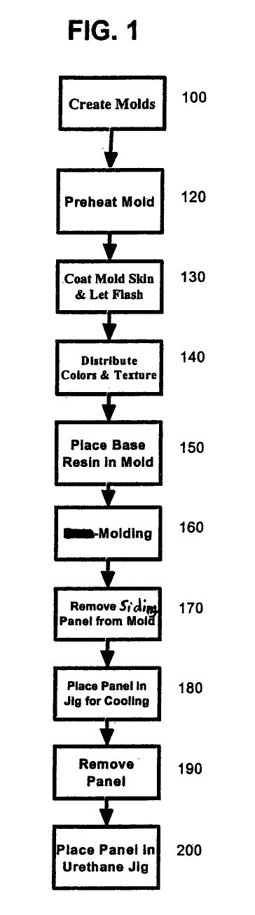

The simulated stone, masonry and brick panels contemplated by the present invention are formed preferably via molding effectuated at temperatures between 400-695° F. In particular, to achieve the stone, masonry and brick panels and structures contemplated by the present invention, it has been found to be preferable to effectuate the multi-step manufacture procedure depicted in the block diagram in FIG. 1. First, in step 120, a specially-designed preferably cast aluminum mold (manufactured in step 100) should be preheated in a molding-oven to an outside mold temperature in the range 350-750° F., and preferably to an outside mold temperature in the range 500-650° F., and more preferably to an outside mold temperature in the range 550-625° F.

It has been found that, generally, the best results contemplated under the present invention are obtained when the outside mold temperature is 575° F. As will be understood by those skilled in the art, it is essential that the temperature of the outside mold be sufficiently elevated in the range 250-400° F. to enable flashing of the modified latex adhesive. It should be understood that the term “flashing” is meant to correspond to substantially removing all of the water from water-based adhesive so that only solids remain; this, of course, avoids the adverse formation of steam in the mold as heat is applied thereto.

After the mold is preheated as hereinbefore described, in step 130, the mold is opened to provide access to its face, for placement of adhesives, pigments, color, and texture components. More particularly, with the mold now opened, the face of the mold is lightly coated with latex glue and allowed to set until the glue flashes or becomes tacky to touch. A typical glue found to be effective for the purposes of the present invention is Henkel MM 8-15-1. It has been found to be particularly effective to spray latex adhesive using an airless spray means in such quantity to assure the in situ retention of coloring pigments and textures. Ergo, it should be clear that this preheating step is incorporated int the instant manufacturing process to enable the modified latex adhesive to be flashed-off the mold surface. That is, the preheating step causes the water portion of the adhesive to evaporate, thereby leaving a solid residue for retaining coloring pigments and textures in place while the resin is melting and being formed into the wall panel contemplated by the present invention.

In the next step depicted in FIG. 1 as numeral 140, the panoply of colors corresponding to the stones and/or masonry and/or bricks being simulated are selected. Color pigments and texturing components are applied to the face of the mold wherein these components preferably become embedded with or integrated into the adhesive. It will be understood that a well-known dry shake method or the like should then preferably be used on the basis that the color pigments and texturing components are preferably in powder form preferably with mesh sizes of no more than the range 10-60.

Referring to a simulated stone and/or masonry and/or brick textured wall panel as an illustrative panel manufactured by the techniques taught by the present invention, it has been found that 2-4 pounds of color components provides the prerequisite color in the wall panel. It has further been found that it is preferable for achieving the high quality simulated stone and/or masonry and/or brick structures and products of the present invention, for neither too much nor too little color pigment and texturing components to be applied in this step. In particular, a range of 5-20% of the total weight of the base resin, corresponding to 4-12 pounds of color pigment and texturing components, has been found to provide suitable simulated stone, masonry and brick embodiments.

Again, using a simulated stone and/or masonry and/or brick wall panel for illustrative purposes, it will become evident that, in proportion to these 4-12 pound color pigments and texturing components, there are 4-12 pounds of a completely formulated and manufactured wall panel—comprising base resin, color pigments and texturing components, and unflashed adhesives. Thus, to produce such a wall panel, a mold contemplated by the present invention is loaded with about 4-12 pounds of polyethylene in conjunction with other polymer and oxide pigments. Color hardener, such as a Coloration Systems hardener, consisting of graded silica aggregates, cement, and mineral oxide pigments, is applied to the face of the mold using a dry shake method.

Next, in step 150, the mold is closed and prepared for a molding cycle. While, of course, any molding apparatus would suffice, it has been found to be preferable to effectuate the molding process (step 160) using a casting oven or similar apparatus. As will become evident to those skilled in the art, the oven temperature should preferably be about 500° F.-650° F. preferably for sufficient time for the resin to become stable. In the following step, depicted as numeral 170, the formed or molded product is unloaded and a new charge of material is reloaded.

In step 180, as should be clear to those skilled in the art, the formed material that has been removed from the mold is then subjected to a cooling cycle in a conventional cooling jig or other suitable cooling receptacle wherein the uniform shape thereof may be sustained.

According to the preferred embodiment, the mold that is used to manufacture panels that simulate stone, masonry and brick have been developed by adapting technology used for manufacturing plastics materials. As will be readily appreciated by those skilled in the plastics molding art, in order to properly and effectively simulate the characteristics of stone, masonry and brick panels—particularly the surface appearance and texture thereof—certain detail is required to be present in the corresponding interior surfaces of the mold. Unfortunately, heretofore, skilled practitioners in the art were unable to produce models which provided the prerequisite surface detail and the like contemplated by the present invention.

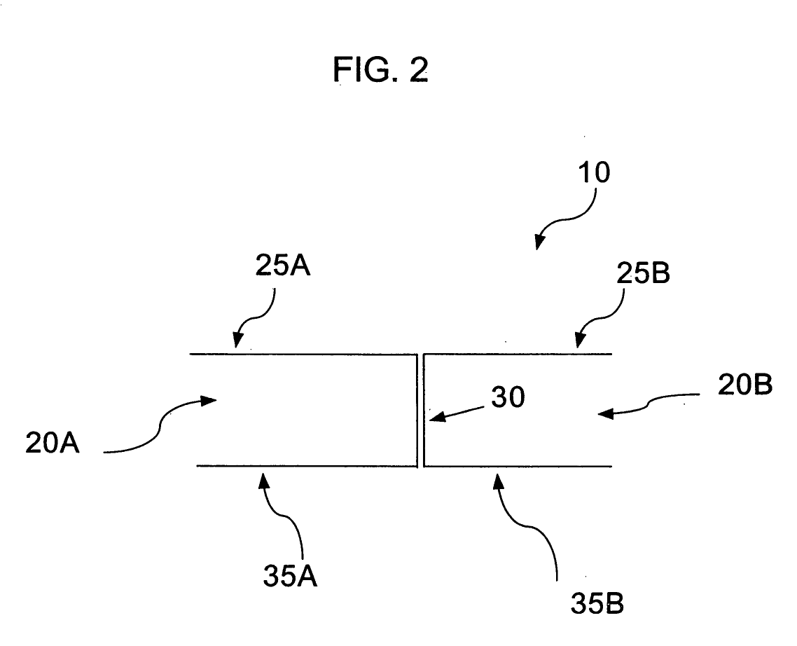

Referring now to FIG. 2, there is shown a simplified frontal view of a typical prior art plastic siding panel 10 intended to simulate stone and/or masonry and/or brick. This structure is comprised of panels 20A and 20B. The obvious artificial character of this plastic panel is clear from the substantially smooth plurality of edges 25A and 35A of panel 20A, and similar top edge 25B and bottom edge 35B of panel 20B. Furthermore, the interface 30 between panels 20A and 20B is also substantially smooth in appearance—clearly not an accurate simulation of stone and/or masonry and/or brick texture.

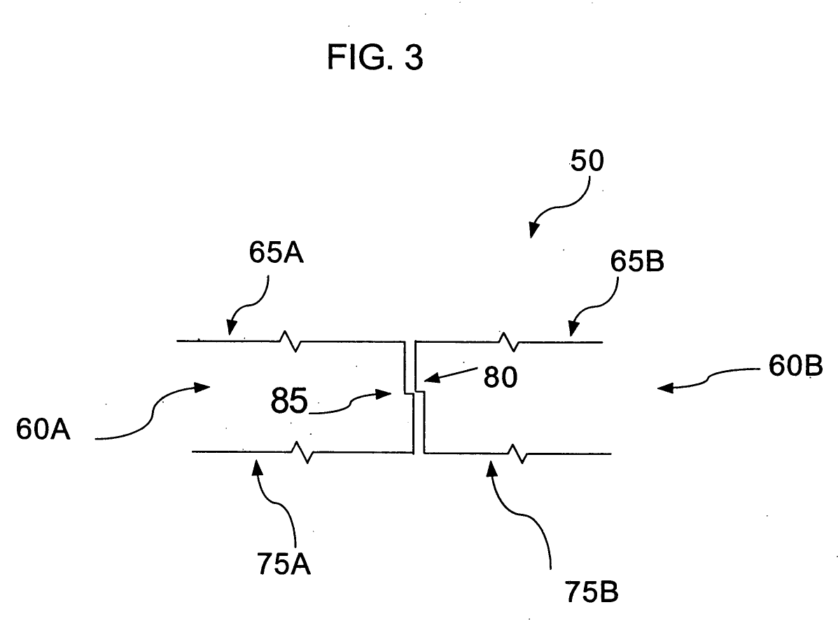

Now referring to FIG. 3, there is shown a simplified frontal view of a plastic siding panel structure 50 intended to simulate stone and/or masonry and/or brick according to the teachings of the present invention. This structure is comprised of siding panels 60A and 60B. The stone-like or masonry-like or brick-like character of this plastic siding panel is clear from the substantially jagged plurality of edges 65A and 75A of panel 60A, and similar top edge 65B and bottom edge 75B of panel 60B. Furthermore, the interface 80 between panels 60A and 60B is specially designed to form step-like structure 85 to properly simulate the uneven joinder between two actual stone or masonry or brick siding panels.

It will be appreciated by those skilled in the art that the mold corresponding to the simulated stone and masonry or brick textured siding panel 50 depicted in FIG. 3 is constructed with deep joints and reveals. The edges of the mold are specially configured to produce the plurality of irregular surfaces and edges that are inherent in stone and masonry and brick panels.

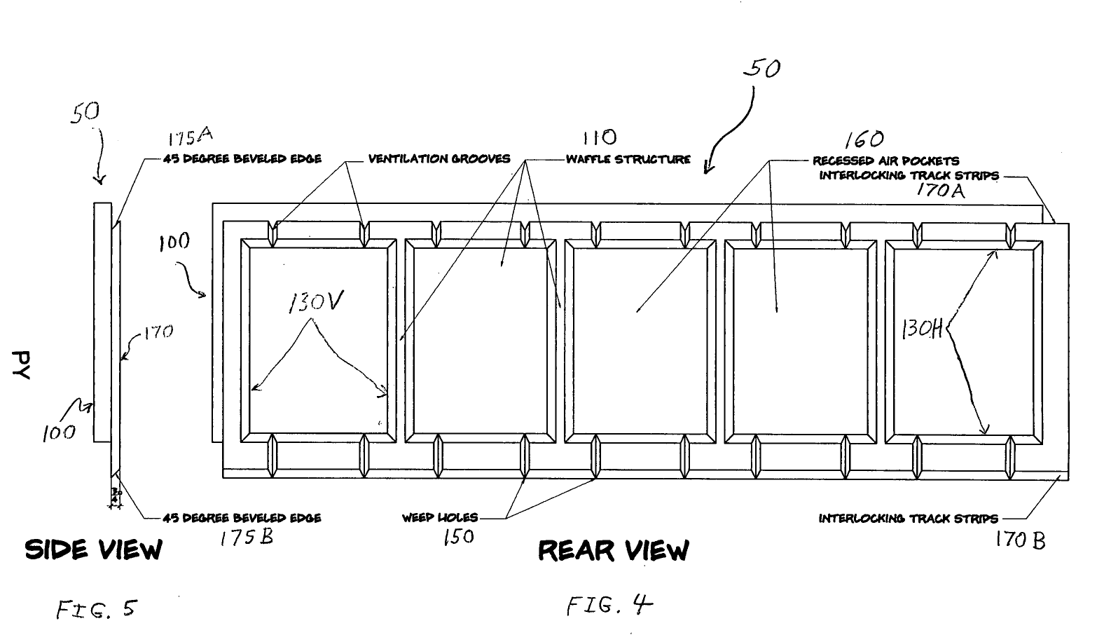

Now referring to FIGS. 4 and 5, there is depicted rear and side views, respectively, of rear portion 100 of siding panel 50, indicative of a preferred embodiment of the present invention correspondingly depicted in FIGS. 1-3. Rear portion 100 has plurality of waffle members 110 that function as a waffle-like structure that tends to facilitate ventilation and drainage of moisture from siding panel 50 as it is affixed in situ. More particularly, plurality of ridges 120 that comprise rear portion 100 are preferably disposed above panel back. It will be appreciated by those skilled in the art that so elevating this plurality of ridges promotes air flow across the grid-backing of siding panel 50. It has been found that raising these ridges approximately ¾ inch affords adequate ventilation and drainage as contemplated hereunder.

As clearly shown in FIGS. 4 and 5, waffle-like grid comprising both a plurality of vertical bars 130V and corresponding plurality of horizontal bars 130H has diagonal pattern of plurality of weep holes 150, plurality of channels and recessed air pockets 160 for allowing air flow and water drainage behind siding panel 50. Top and bottom portions of the grid, as is known in the art, have plurality of interlocking track strips 170A-B preferably scored at a beveled 45° angle to function as a guide for siding panel and screw alignment with other corresponding siding panels. Plurality of upper beveled edges are depicted by numeral 175A and corresponding plurality of lower beveled edges are depicted by numeral 175B. Based upon experience in the art, this beveled edges should preferably be beveled at a 45° angle.

In a manner well known in the art, upper panel's backing grid has a beveled 45° edge which fits the groove on the bottom siding panel's grid backing in order to secure both siding panels to each another, typically in a rabbeted joint. As will be readily appreciated by those skilled in the art, siding panel edges are lapped sidewise, i.e., lapped on their side portion, for rendering a natural look thereto. Each pair of siding panels is rabbeted so that the edge of one panel overlaps the adjacent panel to render a flush or shiplapped joint. As should be known to those skilled in the art, a rabbet is designed to unite the edges of a plurality of siding panels or the like, thereby engendering a corresponding plurality of rabbeted joints. As can be seen from FIGS. 1 and 3-5 herein, a rabbet comprises a cut or groove disposed along or near the edge of a siding panel or the like to enable one siding panel to fit thereinto, constituting a joint.

It is an advantage and feature of the present invention that siding panels produced from the materials hereinbefore described according to the molding techniques of the present invention are not only surprisingly lightweight, but also are readily stacked and layered together. This novel stacked and layered structure enables simulated panels or the like to be used as siding panels for homes, buildings, or the like. It is also an advantage and feature of the present invention that structures and siding panels produced as herein elucidated are surprisingly lightweight and are manufactured in a wide range of colors,

It will be appreciated that embodiments of the present invention may be constructed from not only polyethylene materials, but also from a plethora of other commercially available suitable plastic materials. It should also be clear that an advantage of the present invention is its unique ability to inherently obtain an integrated finish, and, preferably, to obtain a totally integrated finish. It has been discovered that the efficacy of the present invention is also attributable to using synergistic formulations of special adhesives and to preparing suitable molds for receiving other synergistic combinations of virgin and recycled materials as described herein.

It has further been discovered that, indeed, a broad range of plastics may be accommodated by the teachings herein. For instance, such components as rubber, tire rubber, and even chrome rubber may be advantageously used as described herein. As another example of the breadth of the applicability of embodiments of the present invention is that both linear low-density polyethylene and very low-density linear polyethylene may be effectively used.

As will be appreciated by those skilled in the art, an alternative manufacturing procedure of embodiments of the present invention may incorporate compression casting, blow molding, and/or vacuum molding techniques; it has been discovered that vacuforming techniques may also be invoked to produce siding panel embodiments contemplated hereunder. Under these approaches, the specially formulated materials taught herein would be injected or drawn into the prepared mold, respectively, instead of or as a supplement to being loaded into a pre-charged mold. The simulated stone, masonry and brick textured sliding panel embodiments that are thus produced provide the unique characteristics and properties herein elucidated in detail.

Accordingly, it should be clearly understood that the present invention is not intended to be limited by the particular features and structures hereinbefore described and depicted in the accompanying drawings, but that the present invention is to be measured by the scope of the appended claims herein.

1. A method for manufacturing a simulated stone, masonry or brick texture siding panel from a plastic resin, said method comprising the steps of:
preheating in an oven a mold configured to form a suitable shape corresponding to said simulated siding panel;
opening said preheated mold to provide access to its face;
coating said face of said mold with a latex glue material;
allowing said latex glue coating to set until said latex glue flashes off substantially all water contained therein, to yield a solid adhesive residue for retaining coloring pigments and texturing materials;
selecting materials to impart stone, ro masonry or brick colors and textures being simulated;
applying said coloring and texturing materials to said mold face to become embedded with or integrated into said solid adhesive residue;
loading a base resin charge into said mold;
closing said charged mold;
molding said closed charged mold in a temperature range of 500° F-650° F;
unloading said molded base resin charge and re-loading a new charged mold;
cooling said molded base resin charge to sustain said shape of said molded siding panel; and
removing said cooled base resin charge from a cooling jig.

2. The method recited in claim 1, wherein said preheating step preferably preheats said mold to an outside mold temperature in the range 500° F.-650° F.

3. The method recited in claim 1, wherein said preheating step more preferably preheats said mold to an outside mold temperature in the range 550° F.-625° F.

4. The method recited in claim 1, wherein said preheating step still more preferably preheats said mold to an outside mold temperature of 575° F.

5. The method recited in claim 1, wherein said mold is coated with said latex glue using an airless spray means to assure in situ retention of coloring pigments and texturing materials.

6. The method recited in claim 1, wherein said step of applying said coloring and texturing materials to said mold face is performed using a dry shake method.

7. The method recited in claim 1, wherein said coloring and texturing materials are in the range of 5-20% of the total weight of said base resin charge.

8. The method recited in claim 1, wherein said base resin charge comprises linear low density polyethylene.

9. The method recited in claim 1, wherein said molding of said charged mold step proceeds via molding.

10. The method recited in claim 9, wherein said molding of said charged mold step occurs proceeds for 18-22 minutes.

11. The method recited in claim 9, wherein said molding of said charged mold step occurs proceeds with arm rotations set to 10-12 RPM major axis and 6-8 RPM minor axis.

12. The method recited in claim 1, wherein said cooling of said molded base resin charge step comprises injecting cool air into said molded base resin charge.

13. The method recited in claim 12, wherein said air cooling of said molded base resin charge step proceeds for 15-20 minutes.

14. The method recited in claim 13, wherein said cooling of said molded base resin charge step further comprises injecting cool water into said molded base resin charge after said injection of cool air.

15. The method recited in claim 14, wherein said water cooling of said molded base resin charge step proceeds for 1-2 minutes.

16. The method recited in claim 15, wherein said cooling of said molded base resin charge step further comprises injecting subsequent cool air into said molded base resin charge after said injection of cool water.

17. The method recited in claim 16, wherein said subsequent air cooling of said molded base resin charge step proceeds for 1-2 minutes.

18. The method recited in claim 1, wherein said step of cooling said molded base resin charge includes a foam injection step for said simulated stone, masonry or brick siding panel that requires shape retention and sound deadening properties.

19. The method recited in claim 1, wherein said preheating step comprises heating said mold to an outside mold temperature in the range 350° F.-750° F.

20. A method for manufacturing a simulated stone, masonry or brick texture siding panel from a plastic resin, said method comprising the steps of:
preheating in an oven a mold configured to form a suitable shape corresponding to said simulated siding panel;
opening said preheated mold to provide access to its face;
coating said face of said mold with a latex glue material;
allowing said latex glue coating to set until said latex glue flashes off substantially all water contained therein, to yield a solid adhesive residue for retaining coloring pigments and texturing materials;
selecting materials to impart stone, masonry or brick colors and textures being simulated;
applying said coloring and texturing materials to said mold face to become embedded with or integrated into said solid adhesive residue;
closing said charged mold;
loading a base resin charge into said mold;
molding said closed charged mold in a temperature range of 500° F.-650° F;
unloading said molded base resin charge and re-loading a new charged mold;
cooling said molded base resin charge to sustain said shape of said molded product; and
removing said cooled base resin charge to yield said simulated stone, or masonry or brick siding panel.

21. The method recited in claim 20, wherein said preheating step preferably preheats said mold to an outside mold temperature in the range 500° F.-650° F.

22. The method recited in claim 20, wherein said preheating step more preferably preheats said mold to an outside mold temperature in the range 550° F.-625° F.

23. The method recited in claim 20, wherein said preheating step still more preferably preheats said mold to an outside mold temperature of 575° F.

24. The method recited in claim 20, wherein said mold is coated with said latex glue using an airless spray means to assure in situ retention of coloring pigments and texturing materials.

25. The method recited in claim 20, wherein said step of applying said coloring and texturing materials to said mold face is performed using a dry shake method.

26. The method recited in claim 20, wherein said coloring and texturing materials are in the range of 5-20% of the total weight of said base resin charge.

27. The method recited in claim 20, wherein said base resin charge comprises linear low density polyethylene.

28. The method recited in claim 20, wherein said molding of said charged mold step proceeds via molding.

29. The method recited in claim 28, wherein said molding of said charged mold step occurs proceeds for 18-22 minutes.

30. The method recited in claim 28, wherein said molding of said charged mold step occurs proceeds with arm rotations set to 10-12 RPM major axis and 6-8 RPM minor axis.

31. The method recited in claim 20, wherein said cooling of said molded base resin charge step comprises injecting cool air into said molded base resin charge.

32. The method recited in claim 22, wherein said air cooling of said molded base resin charge step proceeds for 15-20 minutes.

33. The method recited in claim 32, wherein said cooling of said molded base resin charge step further comprises injecting cool water into said molded base resin charge after said injection of cool air.

34. The method recited in claim 33, wherein said water cooling of said molded base resin charge step proceeds for 1-2 minutes.

35. The method recited in claim 34, wherein said cooling of said molded base resin charge step further comprises injecting subsequent cool air into said molded base resin charge after said injection of cool water.

36. The method recited in claim 35, wherein said subsequent air cooling of said molded base resin charge step proceeds for 1-2 minutes.

37. The method recited in claim 20, wherein said step of cooling said molded base resin charge includes a foam injection step for said simulated stone, masonry or brick siding panel that requires shape retention and sound deadening properties.

38. The method recited in claim 20, wherein said preheating step comprises heating said mold to an outside mold temperature in the range 350° F.-750° F.
